(19) United States
(12) Patent Application Publication
(10) Pub. No.: US 2010/0258620 A1
(43) Pub. Date: Oct. 14, 2010

(54) METHODS AND SYSTEMS FOR LINKING MULTIPLE ACCOUNTS

(76) Inventors: Denise Torreyson, Elmsford, NY (US); Anant Nambiar, Larchmont, NY (US); Deborah Barta, Wildwood, MO (US); Amy Nevels-Barnett, Saint Peters, MO (US); Anne Henke, Dardenne Prairie, MO (US); Jodi David, Dardenne Prairie, MO (US)

Correspondence Address: DANIEL M. FITZGERALD (21652);ARMSTRONG TEASDALE LLP, 7700 Forsyth Boulevard, Suite 1800, St. Louis, MO, 63105, US

(21) Appl. No.: 12/756,795

(22) Filed: Apr. 8, 2010

Related U.S. Application Data
(60) Provisional application No. 61/168,327, filed on Apr. 10, 2009.

(51) Int. Cl. G06Q 40/00

(52) U.S. Cl. 235/379

(57) ABSTRACT

A method for processing a financial transaction using an interchange network computer coupled to a database is described. The transaction is initiated with a transaction card associated with a linked account. The method includes receiving, at the interchange network computer, a linked account data file for the first transaction card. The data file includes data associating the first card with a first secondary account and data linking the first secondary account to a first primary account. The method also includes storing the data file within the database and receiving a first authorization request message for the first transaction. The method also includes determining, based on data included within the first authorization request message, that the first card is associated with the first secondary account and processing the first authorization request message by applying at least one processing code associated with the first primary account to the first transaction.

### CROSS-REFERENCE TO RELATED APPLICATIONS

This application claims the priority of U.S. Provisional Patent Application Ser. No. 61/168,327, filed Apr. 10, 2009, which is incorporated herein by reference.

### BACKGROUND OF THE INVENTION

The embodiments described herein relate generally to systems and methods for linking multiple accounts and, more particularly to systems and methods for linking at least one secondary account to a primary account wherein at least one of the accounts has a transaction card associated therewith.

The use of transaction cards for consumer transaction payments occurs widely in today's financial world. The payment card industry includes issuing banks, transaction processing associations (e.g., MasterCard®), and third party transaction processing companies (e.g., “merchant acquirers”) that enable cardholders to use transaction cards at merchant establishments, regardless of the merchant's banking relationship with the card issuer. Each cardholder has an account with an issuing bank.

At least some known groups, such as families and employees within a business, include a plurality of members each having a separate transaction card and associated account. When issuing transaction cards to members of these groups, the issuer may assign each member an individual account. While the members of the group are related, the transaction cards and underlying accounts are not linked to a single account for the group. As such, it is difficult to perform analytics on all transaction cards held by the members of the group. For example, to perform analytics, information related to each transaction card is retrieved separately and combined each time analytics are performed. In some cases, it may be almost impossible to determine if cardholders are included within the same group because of a dissimilarity in cardholder names and/or a lack of records establishing a relationship between the cardholders within a group. Moreover, at least some known cardholders are issued different types of transaction cards, such as debit cards, credit cards, consumer transaction cards, and/or business transaction cards. The different types of cards are usually associated with different account numbers and/or transaction card numbers. As such, it is also difficult to perform analytics for an individual cardholder due at least partially to the plurality of transaction cards issued to the cardholder.

In addition, at least some cardholders will lose their transaction cards or their transaction cards will be stolen. These cardholders are oftentimes issued a replacement card. Typically, the replacement transaction card has a different transaction card number and/or account number associated therewith. As such, historical transaction data related to the lost and/or stolen card may be lost when the replacement card is issued. In at least some cases, cardholders are assigned interchange rates based on the amount or number of transactions they charge to their payment cards. In other words, issuers may be paid different interchange rates based on the historical spending of a cardholder. For example, the more the cardholder uses a transaction card the higher the interchange rate may be for the issuer. When a transaction card that qualifies the issuer for a differentiated interchange rate is replaced, the historical spending data related to the qualified transaction card is not carried over to the replacement transaction card. In such a situation, the issuer may no longer qualify for the differentiated interchange rate because the qualifying historical spending data is not associated with the replacement card. When a cardholder having qualifying historical spending repeatedly loses transaction cards, the issuer does not receive the differentiated interchange rate that the issuer would otherwise qualify for if the cardholder did not lose the transaction cards.

Accordingly, there is a need to link to a single account a plurality of transaction cards issued to members of a group and/or a plurality of transaction cards issued to a single cardholder for analytic and/or other purposes. It is desirable that such a method and/or system provide continuous data when a transaction card is replaced and/or provide combined data when the transaction cards are related.

### BRIEF DESCRIPTION OF THE INVENTION

In one aspect, a method for processing a financial transaction using an interchange network computer coupled to a database is provided. The financial transaction is initiated with a transaction card associated with a linked account. The method includes receiving, at the interchange network computer, a linked account data file for the first transaction card. The linked account data file includes data associating the first transaction card with a first secondary account, and data linking the first secondary account to a first primary account. The method also includes storing the linked account data file within the database and receiving a first authorization request message for the first financial transaction. The method also includes determining, based on data included within the first authorization request message, that the first transaction card is associated with the first secondary account. The method also includes processing the first authorization request message by applying at least one processing code associated with the first primary account to the first financial transaction.

In another aspect, a network-based system for processing a financial transaction initiated by application of a transaction card that is associated with a linked account is provided. The system includes a client device associated with a merchant and a database associated with an interchange network for storing a linked account data file. The system also includes a server system coupled to the client device and the database. The server system is associated with the interchange network. The server system is configured to receive the linked account data file from an issuer of the transaction card, the linked account data file including data associating the transaction card with a first secondary account, and data linking the first secondary account to a first primary account. The server system is also configured to store the linked account data file within the database and receive, from the client device, an authorization request for the financial transaction. The server system in also configured to determine, based at least partially on the authorization request, that the transaction card is associated with the first secondary account, and process the authorization request by applying at least one processing code associated with the first primary account to the financial transaction.

In another aspect, a computer for processing a financial transaction using a transaction card account is provided. The computer is coupled to a database and configured to upload a linked account data file from an issuer. The linked account data file includes data linking at least one secondary account to a primary account. The computer is configured to receive a linked account data file for a first transaction card. The linked account data file includes data associating the first transaction card with a first secondary account, and data linking the first secondary account to a first primary account. The computer is also configured to store the linked account data file within the database and receive a first authorization request message for the first financial transaction. The computer is also configured to determine, based on data included within the first authorization request message, that the first transaction card is associated with the first secondary account. The computer is also configured to process the first authorization request message by applying at least one processing code associated with the first primary account to the first financial transaction.

In yet another aspect, a computer program embodied on a non-transitory computer readable medium for processing a financial transaction using an interchange network computer coupled to a database is provided. The financial transaction is initiated with a transaction card associated with a linked account. The program includes at least one code segment for instructing a computer to receive a linked account data file for a first transaction card, the linked account data file including data associating the first transaction card with a first secondary account, and data linking the first secondary account to a first primary account. The program includes at least one code segment to store the linked account data file within the database and receive a first authorization request message for the first financial transaction. The program also includes at least one code segment to determine, based on data included within the first authorization request message, that the first transaction card is associated with the first secondary account, and process the first authorization request message by applying at least one processing code associated with the first primary account to the first financial transaction.

The embodiments described herein facilitate linking related transaction cards. The systems and method described herein include a linked account having a primary account and a plurality of secondary accounts linked to the primary account to facilitate assigning processing codes to transaction cards within the linked accounts.

### BRIEF DESCRIPTION OF THE DRAWINGS

FIGS. 1-15 show exemplary embodiments of the systems and methods described herein.

FIG. 1 is a schematic diagram illustrating an exemplary multi-party payment card industry system for enabling ordinary payment-by-card transactions in which merchants and card issuers do not necessarily have a one-to-one relationship.

FIG. 2 is a simplified block diagram of an exemplary computer system in accordance with one embodiment of the present invention.

FIG. 3 is an expanded block diagram of an exemplary embodiment of a server architecture of the system shown in FIG. 2.

FIG. 4 illustrates an exemplary configuration of a client system shown in FIGS. 2 and 3.

FIG. 5 illustrates an exemplary configuration of a server system shown in FIGS. 2 and 3.

FIG. 6 is a flow diagram of a method of processing a transaction associated with a linked account using the system shown in FIGS. 2 and 3.

FIG. 7 is a schematic diagram illustrating an exemplary linked account that may be used with the method shown in FIG. 6.

FIG. 8 is a schematic diagram illustrating an alternative exemplary linked account that may be used with the method shown in FIG. 6.

FIG. 9 is a flow diagram of a first sub-routine that may be used with the method shown in FIG. 6.

FIGS. 10A, 10B, and 10C show a flow diagram of a second sub-routine that may be used with the method shown in FIG. 6.

FIG. 11 is a schematic diagram illustrating an exemplary linked account that may be used with the method shown in FIGS. 10A, 10B, and 10C.

FIGS. 12A and 12B show a flow diagram of a third sub-routine that may be used with the method shown in FIG. 6.

FIGS. 13A and 13B show a flow diagram of a fourth sub-routine that may be used with the method shown in FIG. 6.

FIG. 14 is a schematic diagram illustrating an exemplary linked account that may be used with the method shown in FIGS. 13A and 13B.

FIG. 15 is a schematic diagram illustrating an alternative exemplary linked account that may be used with the method shown in FIGS. 13A and 13B.

### DETAILED DESCRIPTION OF THE INVENTION

The embodiments described herein provide a system and method for linking accounts having transaction cards associated therewith. More specifically, the embodiments described herein facilitate tracking historical transaction data when transaction cards are replaced and/or facilitate analyzing transaction data for all cards in a household and/or business. Further, the methods and system described herein facilitate storing and/or analyzing transaction data for different types of transaction cards that are related to the same cardholder. The embodiments described herein link transaction cards by forming a linked account that includes a primary account and a plurality of secondary accounts, wherein each secondary account is associated with a transaction card. The linking may be performed before, during, or after multiple transaction cards have been issued to at least one cardholder. For example, when a cardholder is issued a first transaction card associated with a first secondary account, ghost secondary accounts may be linked to the primary account as place-holders for transaction cards to be issued in the future. In such a case, a transaction card number is not usually assigned to the ghost secondary accounts until a subsequent transaction card has been issued.

In one embodiment, the linked account links transaction cards held by each member of a family, company, and/or other organization or group of related cardholders. In an alternative embodiment, the linked account links a lost and/or stolen transaction card to a replacement transaction card. Further, in a particular embodiment, the linked account links a consumer transaction card to a small business transaction card. In an alternative embodiment, the linked account links a credit card to a debit card.

The embodiments described herein enable processing codes to be assigned to transaction cards within the linked account at the primary account level or the secondary account level. For example, an interchange rate can be assigned to transaction cards at the primary account level or the secondary account level depending on the characteristics of the transaction cards within the linked account. In another example, analytics can be performed for each transaction card at the secondary account level and/or can be preformed for all of the transaction cards within the linked account at the primary account level.

The following detailed description illustrates embodiments of the invention by way of example and not by way of limitation. It is contemplated that the invention has general application to processing financial transaction data by a third party in industrial, commercial, and residential applications. As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

As used herein, the term “transaction card” refers to any suitable transaction card, such as a credit card, a debit card, a charge card, a membership card, a promotional card, a frequent flyer card, an identification card, a prepaid card, a gift card, and/or any other device that may hold payment account information, such as mobile phones, personal digital assistants (PDAs), and key fobs. In one embodiment, a computer program is provided, and the program is embodied on a computer readable medium and utilizes a Structured Query Language (SQL) with a client user interface front-end for administration and a web interface for standard user input and reports. In an exemplary embodiment, the system is web enabled and is run on a business-entity intranet. In yet another embodiment, the system is fully accessed by individuals having an authorized access outside the firewall of the business-entity through the Internet. In a further exemplary embodiment, the system is being run in a Windows® environment (Windows is a registered trademark of Microsoft Corporation, Redmond, Wash.). In yet another embodiment, the system is run on a mainframe environment and a UNIXO server environment (UNIX is a registered trademark of AT&T, New York, N.Y.). The application is flexible and designed to run in various different environments without compromising any major functionality.

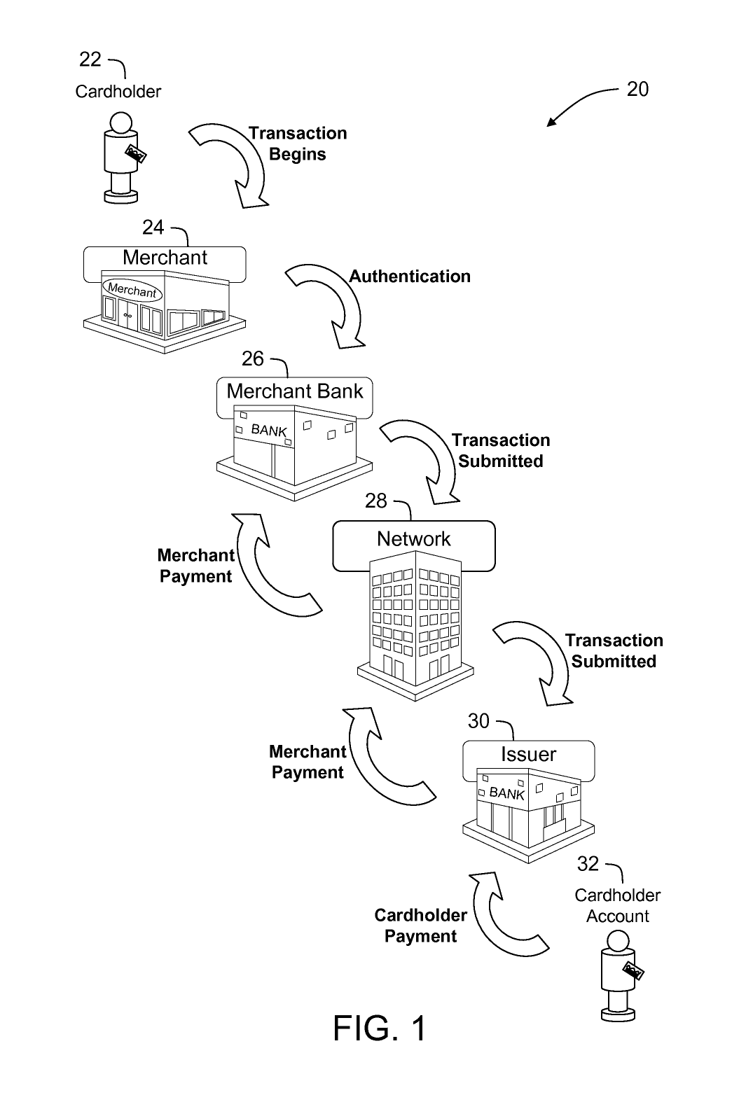

FIG. 1 is a schematic diagram 20 illustrating an exemplary multi-party payment card industry system for enabling ordinary payment-by-card transactions in which merchants and card issuers do not necessarily have a one-to-one relationship. The present invention relates to a payment card system, such as a credit card payment system using the MasterCard® interchange. The MasterCard® interchange is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In a typical payment card system, a financial institution called the “issuer” issues a payment card, such as a credit card, to a consumer, who uses the payment card to tender payment for a purchase from a merchant. To accept payment with the payment card, the merchant must normally establish an account with a financial institution that is part of the financial payment system. This financial institution is usually called the “merchant bank,” the “acquiring bank,” or the “acquirer.” When a consumer 22 tenders payment for a purchase with a payment card (also known as a financial transaction card), the merchant 24 requests authorization from the merchant bank 26 for the amount of the purchase. The request may be performed over the telephone, but is usually performed through the use of a point of sale terminal, which reads the consumer's account information from the magnetic stripe on the payment card and communicates electronically with the transaction processing computers of the merchant bank. Alternatively, a merchant bank may authorize a third party to perform transaction processing on its behalf. In this case, the point of sale terminal will be configured to communicate with the third party. Such a third party is usually called a “merchant processor” or an “acquiring processor.”

Using the interchange network 28, the computers of the merchant bank or the merchant processor will communicate with the computers of the issuer bank 30 to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account 32 is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point of sale terminal. If a consumer cancels a transaction before it is captured, a “void” is generated. If a consumer returns goods after the transaction has been captured, a “credit” is generated.

For debit card transactions, when a request for a PIN authorization is approved by the issuer, the consumer's account 32 is decreased. Normally, a charge is posted immediately to a consumer's account. The bankcard association then transmits the approval to the acquiring processor for distribution of goods/services, or information or cash in the case of an ATM.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group.

Financial transaction cards or payment cards can refer to credit cards, debit cards, and prepaid cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), and key fobs.

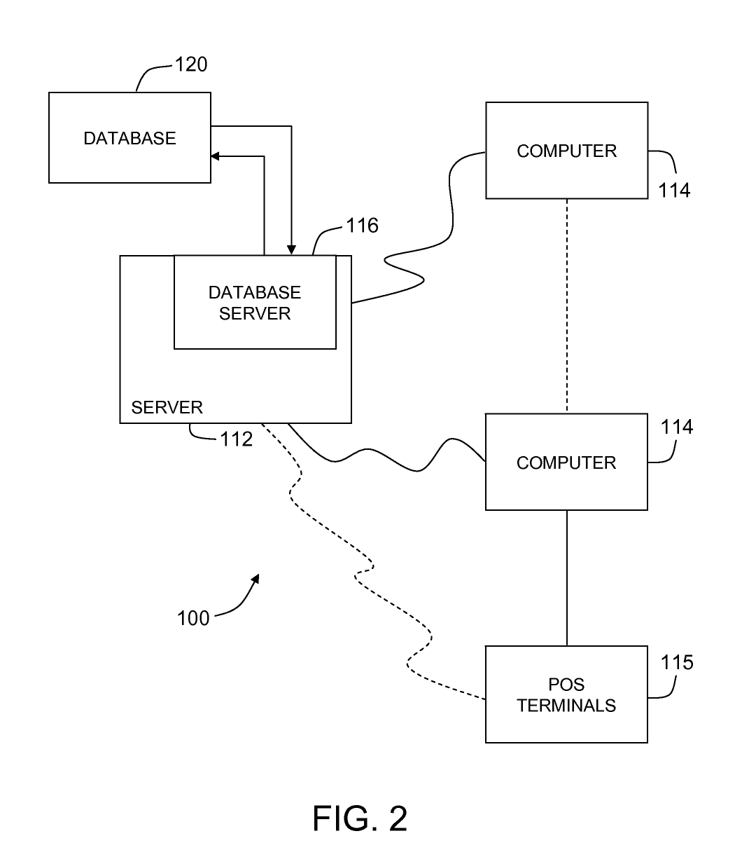

FIG. 2 is a simplified block diagram of an exemplary system 100 in accordance with one embodiment of the present invention. System 100 is a payment card system, which can be utilized by account holders as part of a process of initiating an authorization request and transaction as described below.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed ISDN lines. Client systems 114 could be any device capable of interconnecting to the Internet including a web-based phone, personal digital assistant (PDA), or other web-based connectable equipment.

System 100 also includes point of sale (POS) terminals 115, which are connected to client systems 114 and may be connected to server system 112. POS terminals 115 are interconnected to the Internet through many interfaces including a network, such as a local area network (LAN) or a wide area network (WAN), dial-in-connections, cable modems, wireless modems, and special high-speed ISDN lines. POS terminals 115 could be any device capable of interconnecting to the Internet and including an input device capable of reading information from a consumer's financial transaction card and/or receiving manually entered transaction card information.

A database server 116 is connected to database 120, which contains information on a variety of matters, as described below in greater detail. Database 120 is also referred to herein as a data warehouse. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may store transaction data generated as part of sales activities conducted over the bankcard network including data relating to merchants, account holders or customers, and purchases. Database 120 may also store data relating to a list of merchants participating in programs with the interchange network; a linked account data file including a plurality of linked account groups wherein each linked account group includes a primary account and a plurality of secondary accounts linked to the primary account; account numbers including each primary account number and each secondary account number; interchange rate data for different types of transactions performed over the interchange network; and rewards program data for different rewards programs offered by the issuer or the interchange network.

In the example embodiment, one of client systems 114 may be associated with an acquirer while another one of client systems 114 may be associated with an issuer, POS terminal 115 may be associated with a participating merchant, and server system 112 may be associated with the interchange network.

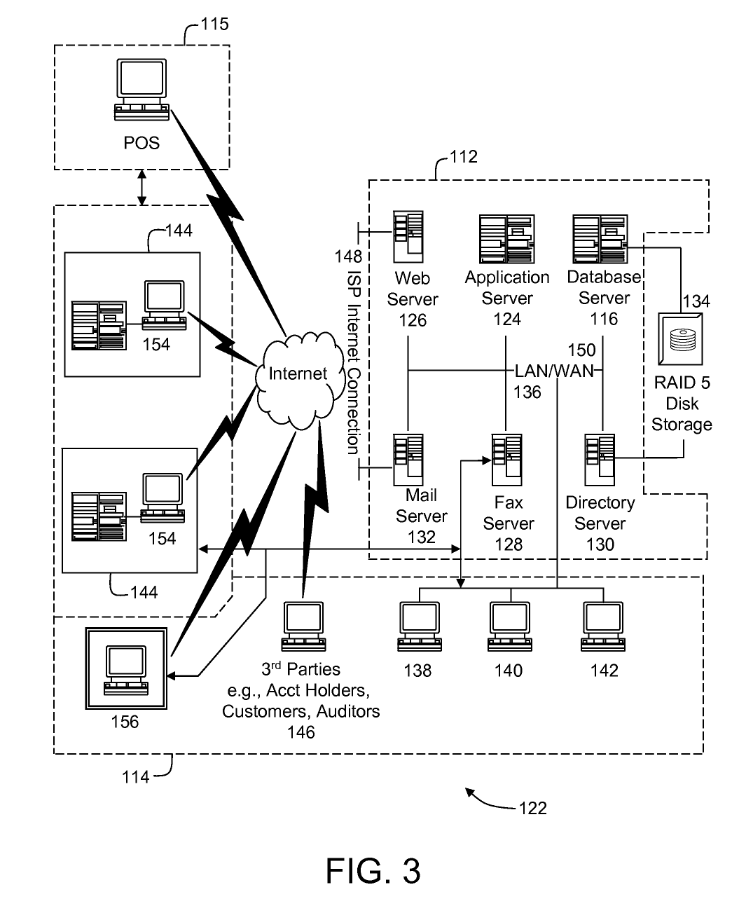

FIG. 3 is an expanded block diagram of an exemplary embodiment of a server architecture of a system 122 in accordance with one embodiment of the present invention. Components in system 122, identical to components of system 100 (shown in FIG. 2), are identified in FIG. 3 using the same reference numerals as used in FIG. 2. System 122 includes server system 112, client systems 114 and POS terminals 115. Server system 112 further includes database server 116, an application server 124, a web server 126, a fax server 128, a directory server 130, and a mail server 132. A disk storage unit 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, etc., 146 using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 146 using a telephone link. Fax server 128 is configured to communicate with other client systems 138, 140, and 142 as well.

As used herein, the terms “software” and “firmware” are interchangeable, and include any computer program stored in memory for execution by personal computers, workstations, clients and servers, including RAM memory, ROM memory, EPROM memory, EEPROM memory, and non-volatile RAM (NVRAM) memory. The above memory types are exemplary only, and are thus not limiting as to the types of memory usable for storage of a computer program.

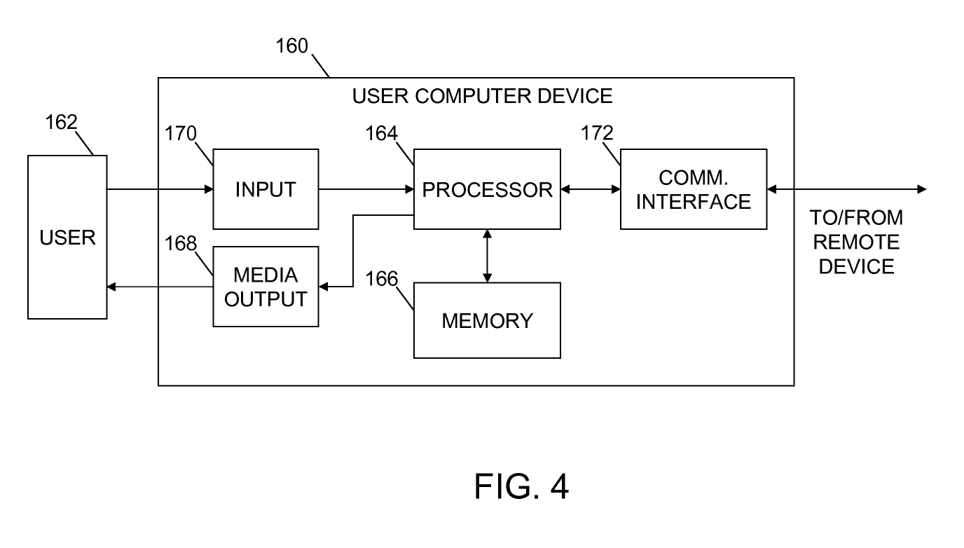

FIG. 4 illustrates an exemplary configuration of a user computer device 160 operated by a user 162. User computer device 160 may include, but is not limited to, client systems 114, 138, 140, and 142, POS terminal 115, workstation 154, and manager workstation 156 (shown in FIGS. 2 and 3).

User computer device 160 includes a processor 164 for executing instructions. In some embodiments, executable instructions are stored in a memory area 166. Processor 164 may include one or more processing units (e.g., in a multi-core configuration). Memory area 166 is any device allowing information such as executable instructions and/or transaction data to be stored and retrieved. Memory area 166 may include one or more computer readable media.

User computer device 160 also includes at least one media output component 168 for presenting information to user 162. Media output component 168 is any component capable of conveying information to user 162. In some embodiments, media output component 168 includes an output adapter (not shown) such as a video adapter and/or an audio adapter. An output adapter is operatively coupled to processor 164 and operatively couplable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 168 is configured to present a graphical user interface (e.g., a web browser and/or a client application) to user 162. A graphical user interface may include, for example, an online store interface for viewing and/or purchasing items, and/or a wallet application for managing payment information.

In some embodiments, user computer device 160 includes an input device 170 for receiving input from user 162. User 162 may use input device 170 to select and/or enter, without limitation, one or more items to purchase, a purchase request, access credential information, and/or payment information. Input device 170 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 168 and input device 170.

User computer device 160 may also include a communication interface 172, which is communicatively couplable to a remote device such as server system 112 (shown in FIG. 2). Communication interface 172 may include, for example, a wired or wireless network adapter and/or a wireless data transceiver for use with a mobile telecommunications network.

Stored in memory area 166 are, for example, computer readable instructions for providing a user interface to user 162 via media output component 168 and, optionally, receiving and processing input from input device 170. A user interface may include, among other possibilities, a web browser and/or a client application. Web browsers enable users, such as user 162, to display and interact with media and other information typically embedded on a web page or a website from server system 112. A client application allows user 162 to interact with a server application of a merchant computer system, POS terminal 115, and/or server system 112.

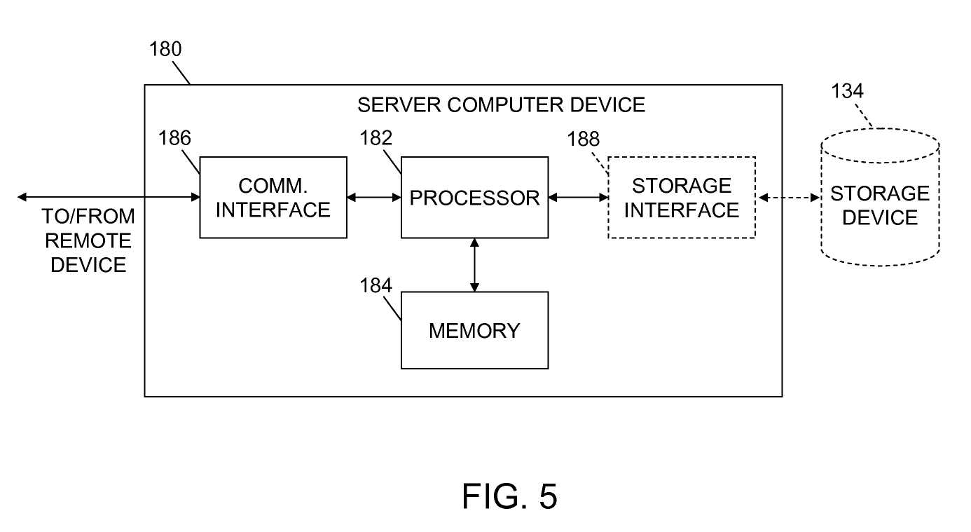

FIG. 5 illustrates an exemplary configuration of a server computer device 180 such as server system 112 (shown in FIG. 2). Server computer device 180 may include, but is not limited to, a merchant computer system, POS terminal 115, database server 116, application server 124, web server 126, fax server 128, directory server 130, and/or mail server 132.

Server computer device 180 also includes a processor 182 for executing instructions. Instructions may be stored in, for example, but not limited to, a memory area 184. Processor 182 may include one or more processing units (e.g., in a multi-core configuration).

Processor 182 is operatively coupled to a communication interface 186 such that server computer device 180 is capable of communicating with a remote device such as user computer device 160 (shown in FIG. 4) or another server computer device 180. For example, communication interface 186 may receive requests from user computer device 114 via the Internet, as illustrated in FIG. 3.

Processor 182 may also be operatively coupled to a storage device 134. Storage device 134 is any computer-operated hardware suitable for storing and/or retrieving data, such as, but not limited to, data associated with database 120. In some embodiments, storage device 134 is integrated within server computer device 180. For example, server computer device 180 may include one or more hard disk drives as storage device 134. In other embodiments, storage device 134 is external to server computer device 180 and may be accessed by a plurality of server computer devices 180. For example, storage device 134 may include multiple storage units such as hard disks and/or solid state disks in a redundant array of inexpensive disks (RAID) configuration. Storage device 134 may include a storage area network (SAN) and/or a network attached storage (NAS) system.

In some embodiments, processor 182 is operatively coupled to storage device 134 via a storage interface 188. Storage interface 188 is any component capable of providing processor 182 with access to storage device 134. Storage interface 188 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 182 with access to storage device 134.

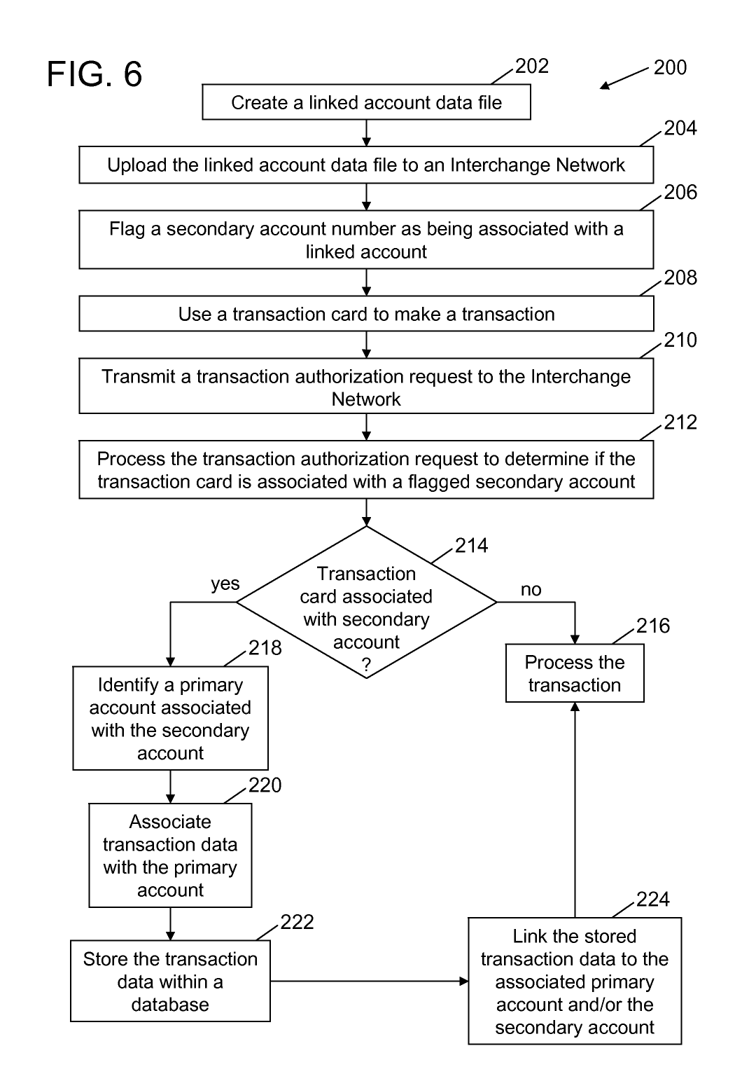

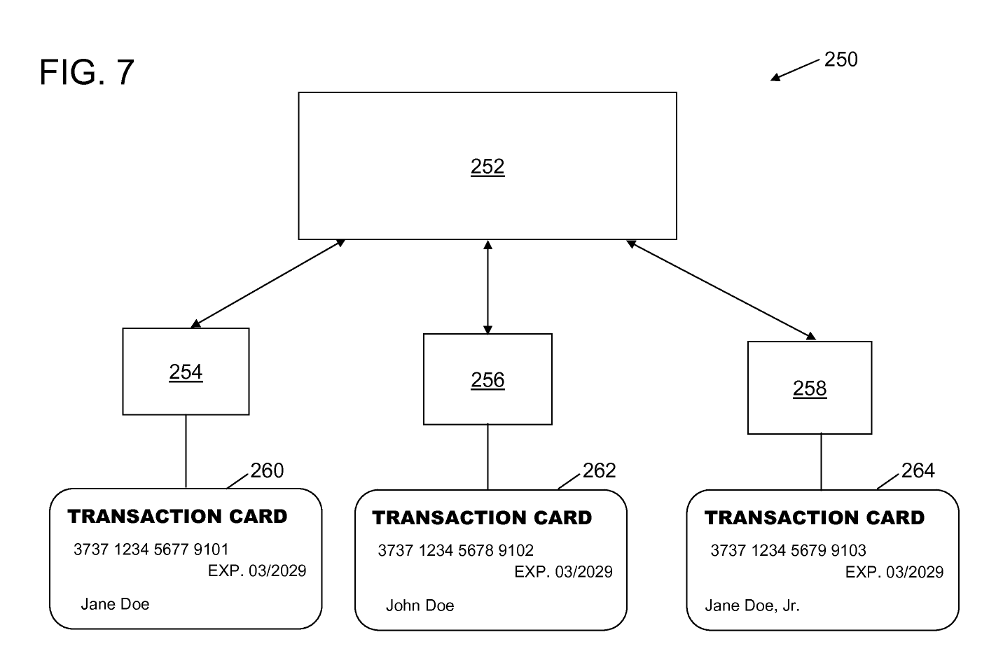

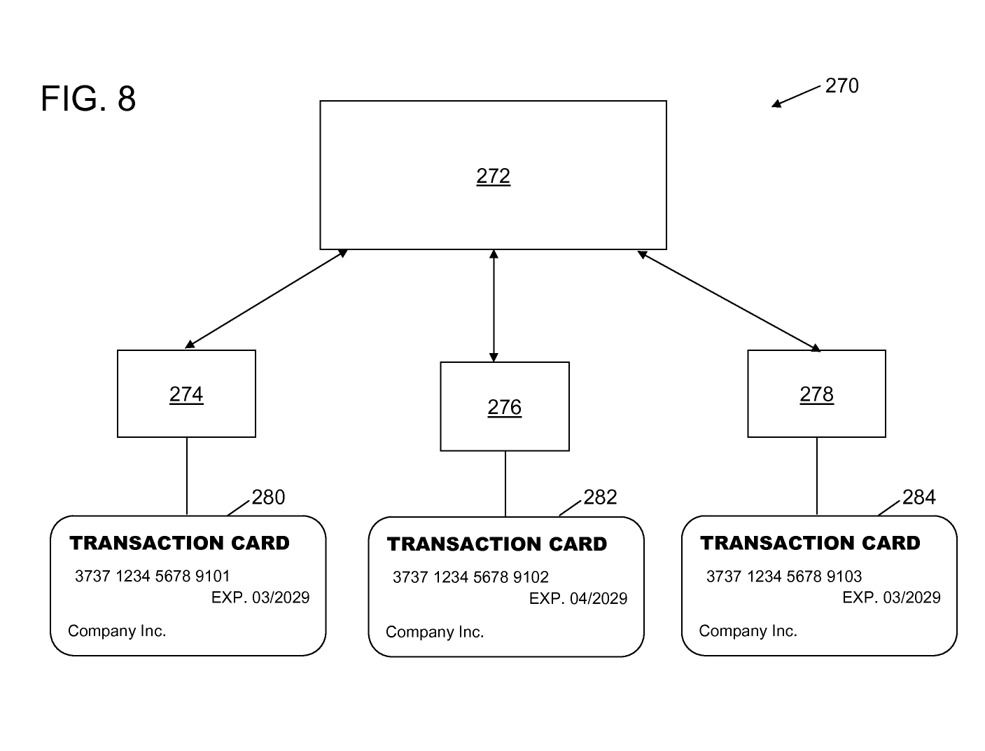

FIG. 6 is a flow diagram of a method 200 of processing a transaction associated with a linked account in accordance with an exemplary embodiment of the present invention. In the exemplary embodiment, method 200 is performed using the systems shown in FIGS. 1-3. FIG. 7 is a schematic diagram illustrating an exemplary linked account 250 that may be used with method 200. FIG. 8 is a schematic diagram illustrating an alternative exemplary linked account 270 that may be used with method 200. In the exemplary embodiment, method 200 is directed to creating a linked account, such as linked account 250 and/or linked account 270, and processing a transaction made using a transaction card associated with the linked account.

As shown in FIG. 7, linked account 250 (also referred to as linked account group) includes a primary account 252 and a plurality of secondary accounts 254, 256, and 258 linked to primary account 252. A transaction card 260, 262, and 264 is associated with each secondary account 254, 256, and 258, respectively. More specifically, linked account 250 includes a household of transaction cards 260, 262, and 264 such that all transaction cards 260, 262, and 264 issued to each member of a family are linked to a single primary account 252. Transaction cards 260, 262, and/or 264 may be associated with the same issuer account number and/or at least one transaction card 260, 262, and/or 264 may be associated with a different issuer account number. Although three transaction cards are shown in FIG. 7 for exemplary purposes, any number of transaction cards may be used and linked to a single primary account.

As shown in FIG. 8, linked account 270 includes a primary account 272 and a plurality of secondary accounts 274, 276, and 278 linked to primary account 272. A transaction card 280, 282, and 284 is associated with each secondary account 274, 276, and 278, respectively. More specifically, linked account 270 includes a plurality of business transaction cards 280, 282, and 284 such that all transaction cards 280, 282, and 284 issued to a business are linked to a single primary account 272. Transaction cards 280, 282, and/or 284 may be associated with the same issuer account number and/or at least one transaction card 280, 282, and/or 284 may be associated with a different issuer account number. Although linked account 250 is used in the following description of method 200, it should be understood that linked account 270 and/or any other suitable group of transaction cards may be used with method 200.

Referring to FIGS. 6 and 7, method 200 includes creating 202 a linked account data file. More specifically, an issuer, such as issuer 30 (shown in FIG. 1), creates 202 the linked account data file that includes linked account information. The linked account information includes information relating to a plurality of linked accounts. Each linked account includes a primary account assigned to a cardholder and a plurality of secondary accounts linked to the primary account. Each primary account in the linked account data file has a unique primary account number, and each of the plurality of secondary accounts linked to the primary accounts has a unique secondary account number. Although described herein as including account numbers, the linked account data file may store any type of account identifier that enables identification of accounts and/or transaction cards.

Once the linked data file has been created 202, the linked account data file is uploaded 204 from issuer 30 to interchange network 28 (shown in FIG. 1) for storage within a data warehouse, such as database or data warehouse 120 (shown in FIG. 2). Data warehouse 120 may be stored on a server that is accessible by interchange network 28 and/or may be stored within the same server as interchange network 28. In the exemplary embodiment, interchange network 28 flags 206 each secondary account number within the uploaded linked account data file as being part of a linked account. In one embodiment, interchange network 28 flags 206 a secondary account number by adding a linked account code to a secondary account code, such as a secondary account code associated with a transaction card that is related to the secondary account.

In the exemplary embodiment, the cardholder uses 208 transaction card 260 having an account number assigned thereto to make a purchase and/or other transaction at a point of sale (POS) terminal 115 (shown in FIG. 2) and/or other suitable device associated with a merchant, such as merchant 24 (shown in FIG. 1). Transaction card 260 is issued by issuer 30 and associated with, for example, secondary account 254. The merchant transmits 210 a transaction authorization request from POS terminal 115 to interchange network 28. The transaction authorization request includes the account number from transaction card 260 and transaction data representing the transaction made by the cardholder.

Interchange network 28 processes 212 the transaction authorization request, which includes determining 214 whether transaction card 260 is associated with one of the flagged secondary accounts. More specifically, interchange network 28 determines 214 if transaction card 260 is associated with a flagged secondary account by accessing the linked account data file that includes the account number from transaction card 260. If the transaction card is not associated with a flagged secondary account (i.e., the secondary account code associated with the secondary account does not include a linked account code), the transaction is processed 216 as described above with respect to FIG. 1 to complete the transaction. If transaction card 260 is associated with a flagged secondary account 254, a primary account to which transaction card 260 is linked is identified 218. More specifically, interchange network 28 identifies secondary account 254 as being associated with transaction card 260, and identifies 218 primary account 252 as being associated with secondary account 254. In the exemplary embodiment, interchange network then associates 220 the transaction data with the identified primary account 252.

After associating 220 the transaction data with primary account 252, the transaction data is stored 222 within data warehouse 120. Storing 222 the transaction data includes linking 224 the transaction data stored 222 within data warehouse 120 to secondary account 254 associated with transaction card 260 and to the identified primary account 252. The transaction is processed 216 as described with respect to FIG. 1 to complete the transaction.

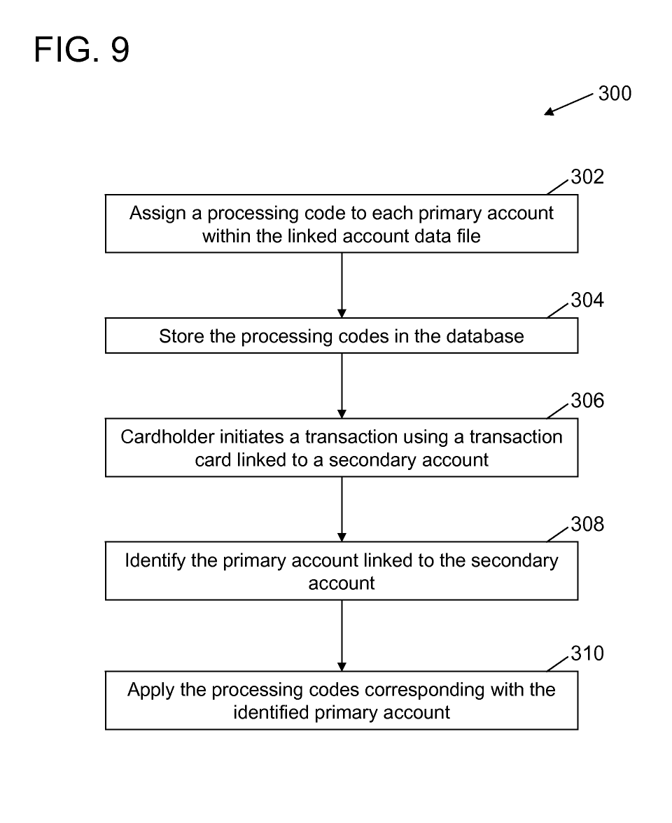

FIG. 9 is a flow diagram of a first sub-routine 300 that may be used with method 200 (shown in FIG. 6). Sub-routine 300 is a method for applying processing codes including interchange rates at a primary account level. As used herein, the term “interchange rate” refers to a percentage rate applied to each transaction conducted through interchange network 28 (shown in FIG. 1) to determine interchange fees that are generally paid by acquirers to card issuers on purchase transactions conducted using transaction cards through interchange network 28. In the exemplary embodiment, sub-routine 300 includes assigning 302 processing codes to each primary account at interchange network 28. The processing codes include an interchange rate for processing a transaction that uses a transaction card over interchange network 28. The processing codes are stored 304 in data warehouse 120 within an associated linked account data file.

A cardholder then initiates 306 a transaction using a transaction card that is associated with a secondary account, and the primary account linked to the secondary account is identified 308. After the primary account linked to the secondary account that is associated with the transaction card is identified, the processing codes assigned to the identified primary account are applied 310 to data associated with the transaction, to complete the transaction. Applying 310 the processing codes includes applying 310 the interchange rate assigned to the identified primary account to the transaction data.

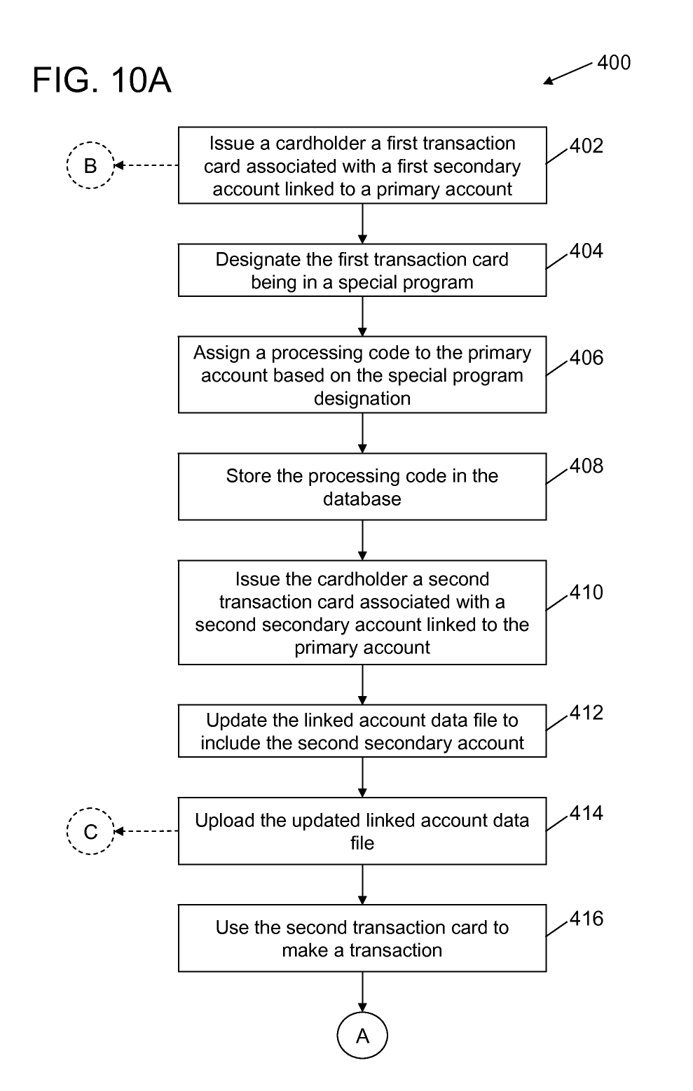

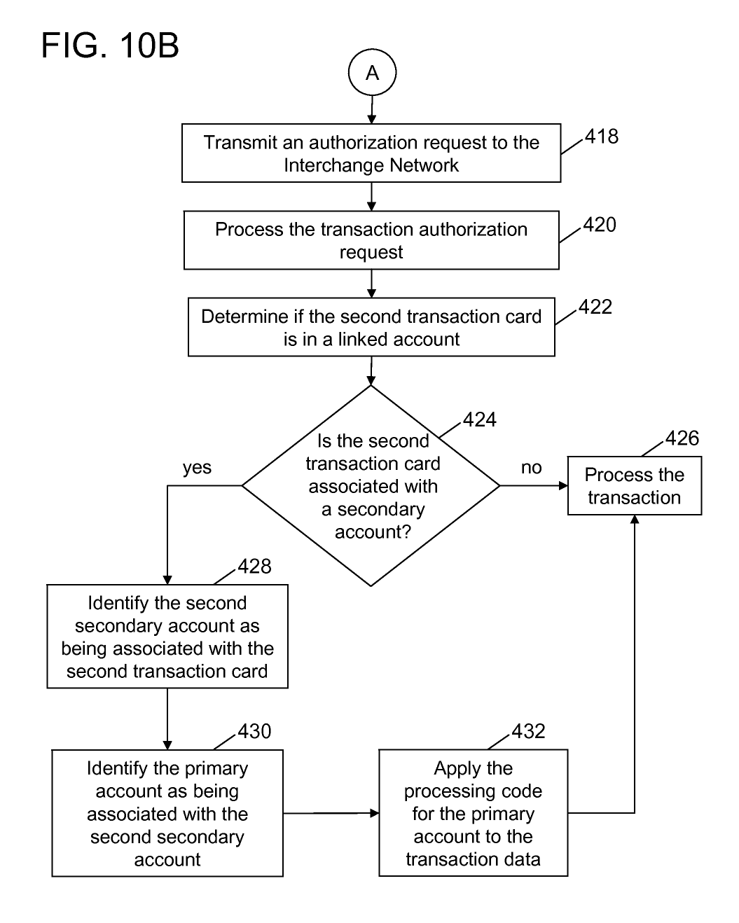

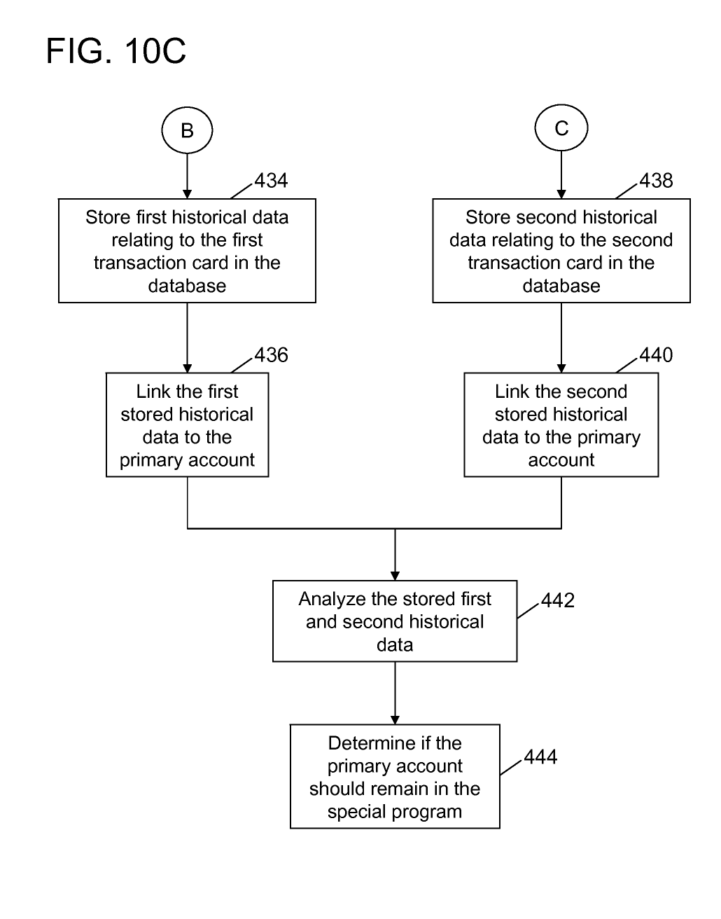

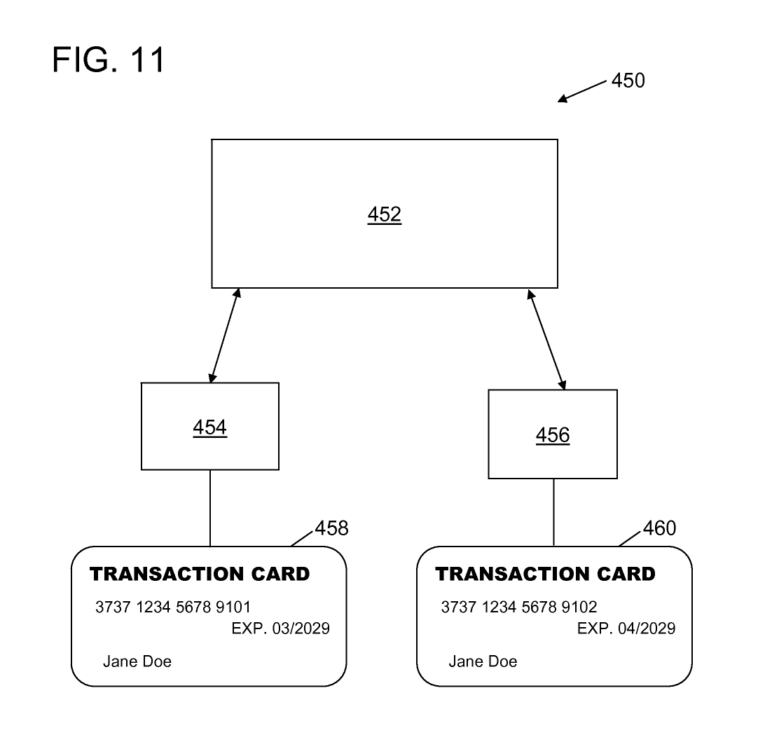

FIGS. 10A, 10B, and 10C show a flow diagram of a second sub-routine 400 that may be used with method 200 (shown in FIG. 6). FIG. 11 is a schematic diagram illustrating an exemplary linked account group 450 that may be used with sub-routine 400. Sub-routine 400 is a method of tracking historical data when a transaction card is replaced. Linked account group 450 is referred to herein to describe sub-routine 400, however it should be understood that other suitable linked accounts may be used with sub-routine 400. For example, a linked account could include a plurality of inactive transaction cards and at least one active transaction card.

Referring to FIG. 11, in the exemplary embodiment, linked account 450 includes a primary account 452 and at least two secondary accounts 454 and 456 linked to primary account 452. A transaction card 458 and 460 is associated with each secondary account 454 and 456, respectively. Transaction cards 458 and 460 are both associated with the same card account and/or cardholder at issuer 30 (shown in FIG. 1). More specifically, in the exemplary embodiment, transaction card 458 has been reported lost and/or stolen, transaction card 460 is a replacement for transaction card 458. As such, transaction card 458 is inactive, and transaction card 460 is active. For example, when a cardholder attempts to use transaction card 458 to make a transaction, the transaction will be declined by issuer 30.

Referring to FIGS. 10A, 10B, and 11, sub-routine 400 includes issuing 402 a cardholder first transaction card 458 that is associated with a first secondary account 454 that is linked to a first primary account 452. First primary account 452 is one of the primary accounts in the linked account data file described with respect to FIG. 6. In the exemplary embodiment, first primary account 452 is designated 404 as being in a special program. For example, first primary account 452 is designated 404 as being a High Value account. As used herein, the term “High Value” refers to a transaction card account that meets or exceeds a predetermined spend criteria, such as a number of transactions and/or an amount spent using the transaction card account, and qualifies an issuer of the transaction card account to receive a premium interchange rate (i.e., a higher rate than that received for non-High Value accounts). In one embodiment, first primary account 452 is designated 404 as being in the special program when the cardholder frequently uses his/her transaction card.

In the exemplary embodiment, processing codes are assigned 406 to first primary account 452 at interchange network 28 (shown in FIG. 1). The assigned processing codes reflect the special program designation and include the premium interchange rate. In the exemplary embodiment, when first primary account 452 is designated 404 as being in the special program, first primary account 452 is assigned 406 an interchange rate that includes a premium amount that is higher than the interchange rate for accounts not in the special program. The processing codes for first primary account 452 are stored 408 in data warehouse 120.

The cardholder is issued 410 second transaction card 460 that is associated with second secondary account 456 and has a second account number assigned thereto. Second secondary account 456 is linked to first primary account 452, and second transaction card 460 replaces first transaction card 458. First transaction card 458 is replaced because, for example, first transaction card 458 is reported lost and/or stolen. The linked account data file is updated 412 by issuer 30 to include second secondary account information, and the updated linked account data file is uploaded 414 to interchange network 28 from issuer 30. The updated linked account data file is stored within data warehouse 120. The updated linked account data file includes data reflecting the linking of second secondary account 456 to first primary account 452.

The cardholder uses 416 second transaction card 460 to initiate a transaction at POS terminal 115 (shown in FIG. 2) associated with merchant 24 (shown in FIG. 1). Alternatively, the cardholder uses 416 second transaction card 460 to initiate any suitable transaction. In the exemplary embodiment, when the cardholder uses first transaction card 458 to make a transaction after second transaction card 460 has been issued 410 to the cardholder, issuer 30 declines the transaction. In the exemplary embodiment, when the cardholder uses 416 second transaction card 460 to initiate a transaction, merchant 24 transmits 418 a transaction authorization request from POS terminal 115 to interchange network 28. The transaction authorization request includes the second account number and transaction data representing the transaction made by the cardholder.

Interchange network 28 processes 420 the transaction authorization request. More specifically, interchange network 28 processes 420 the transaction authorization request to determine 422 if second secondary account 456 is within a linked account. If second secondary account 456 is not within a linked account, interchange network 28 processes 426 the transaction as described above with respect to FIG. 1 to complete the transaction. If second secondary account 456 is within linked account group 450, interchange network 28 identifies 428 the second account number as being associated with second secondary account 456 and identifies 430 second secondary account 456 as being linked to first primary account 452.

After first primary account 452 has been identified 430, the processing codes for first primary account 452 are applied 432 to the transaction data, including applying the special program interchange rate assigned to first primary account 452 to the transaction data. Interchange network 28 then processes 426 the transaction using the processing codes to complete the transaction.

Referring to FIGS. 10A, 10C, and 11, sub-routine 400 additionally or alternatively includes analytics steps. More specifically, sub-routine 400 includes storing 434 first historical transaction data associated with first transaction card 458 in data warehouse 120, and linking 436 the first historical transaction data to first primary account 452. Similarly, second historical transaction data associated with second transaction card 460 is stored 438 in data warehouse 120 and is linked 440 to first primary account 452. The first and/or second historical transaction data is analyzed 442 for a predetermined period of time, such as twelve months. In the exemplary embodiment, the first and/or second historical transaction data is analyzed 442 to determine 444 whether first primary account 452 should qualify for and/or remain in the special program based on the analysis 442 of the historical transaction data linked to first primary account 452. Alternatively, first and/or second historical transaction data is analyzed 442 to determine offers to make to the cardholder.

In a particular embodiment, the determination 444 of special program status is performed quarterly, however, the determination 444 can be made as often as is suitable. Further, although the first and/or second historical transaction data is analyzed 442 for the predetermined period of time, the first and/or second historical transaction data can be stored 434 and/or 438 for any suitable length of time, such as three years, for performing analytics using the first and/or second historical transaction data.

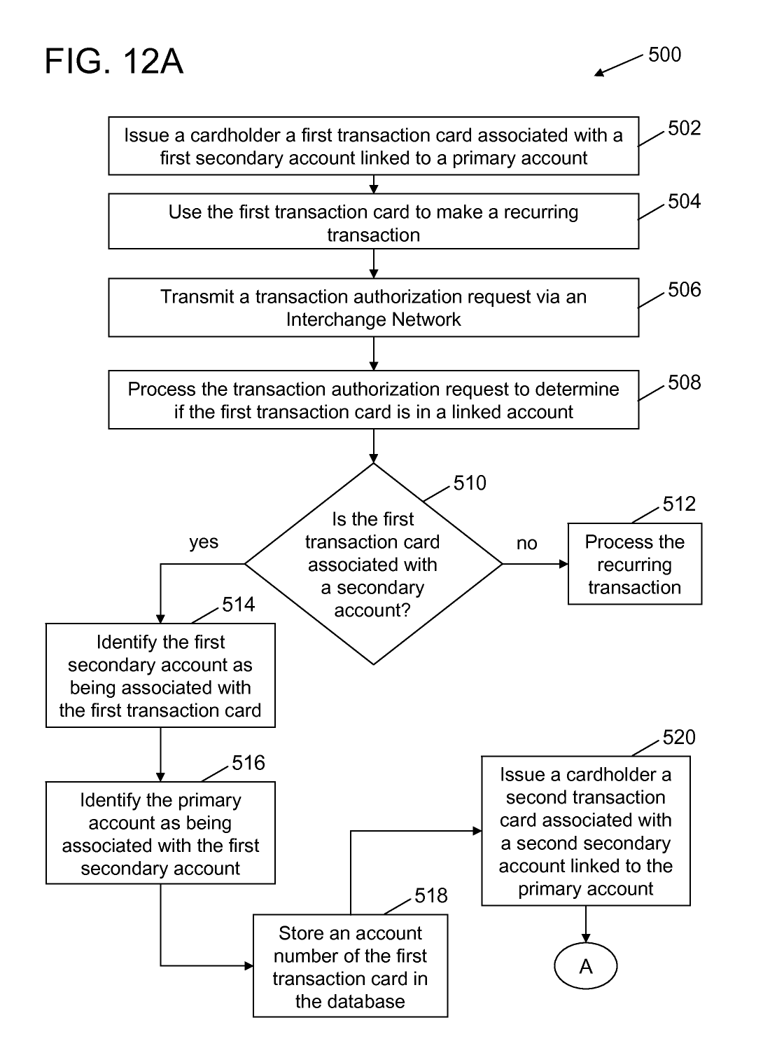

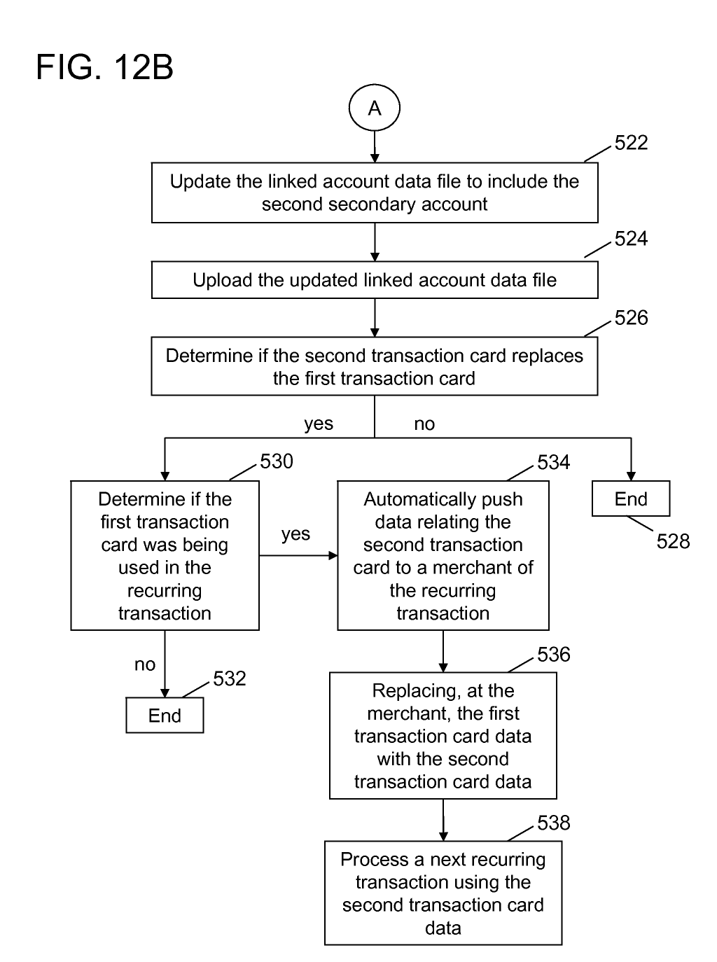

FIGS. 12A and 12B show a flow diagram of a third sub-routine 500 that may be used with method 200 (shown in FIG. 6) and linked account 450 (shown in FIG. 11). Alternatively, sub-routine 500 may be used with any suitable linked account. In the exemplary embodiment, sub-routine 500 is a method of performing a recurring transaction when a transaction card is replaced.

Referring to FIGS. 11, 12A, and 12B, sub-routine 500 includes issuing 502 a cardholder first transaction card 458 that is associated with first secondary account 454, which is linked to first primary account 452. First transaction card 458 has a first account number associated therewith. The cardholder uses 504 first transaction card 458 to make a recurring purchase or payment. These transactions are sometimes referred to as “card-not-present recurring payment” (CNP/RP) transactions. Specifically, CNP/RP transactions are payment transactions that use transaction card information stored by a merchant and wherein the transaction card is not present for the actual transaction. For example, a health club member may wish to avoid mailing a monthly check for club membership dues. The member may instead register a transaction card, such as a credit card, a debit card, or a prepaid card, with the club, enabling the club to automatically charge the transaction card for the monthly dues on a particular day each month. In some such systems, the merchant stores an account number, an expiration date, and/or other information associated with the transaction card and/or cardholder. The cardholder gives ongoing permission to the merchant to submit a payment request (i.e., to initiate a transaction) on behalf of the cardholder. The payment request may be submitted through POS terminal 115 (shown in FIG. 2) associated with merchant 24 (shown in FIG. 1) and/or through a merchant computer system. Alternatively, the cardholder uses 504 first transaction card 458 to make any suitable recurring transaction by, for example, entering account data into a merchant website. In the exemplary embodiment, when the cardholder uses 504 first transaction card 458 to make each recurring transaction, merchant 24 transmits 506 a transaction authorization request from POS terminal 115 to server system 112, which is associated with interchange network 28 (shown in FIG. 1). The transaction authorization request includes the first account number and transaction data representing the recurring purchase made by the cardholder.

Interchange network 28 processes 508 the transaction authorization request to determine 510 whether first transaction card 458 is associated with an account that is within a linked account group. If first transaction card 458 is not within a linked account group, interchange network 28 processes 512 the recurring transaction as described above with respect to FIG. 1 to complete each recurring transaction. If first transaction card 458 is in linked account 450, interchange network 28 identifies the first account number as being associated with first secondary account 454. More specifically, interchange network 28 identifies 514 first secondary account 454 as being associated with first transaction card 458, and identifies 516 first primary account 452 as being associated with first secondary account 454. As such, interchange network 28 identifies the first account number as being associated with first secondary account 454 and linked to first primary account 452. The first account number and recurring purchase data are stored 518 in data warehouse 120.

The cardholder is issued 520 second transaction card 460 having a second account number that is associated with second secondary account 456. Second secondary account 456 is linked to first primary account 452, and second transaction card 460 replaces first transaction card 458. For example, if first transaction card 458 is reported as lost and/or stolen, second transaction card 460 replaces first transaction card 458. More specifically, the first account number is rendered inactive, and the second account number becomes the active account number. In the exemplary embodiment, the linked account data file is updated 522 to include second secondary account 456. As such, the updated data file includes data reflecting the linking of second secondary account 456 to first primary account 452. The updated linked account data file is uploaded 524 from issuer 30 (shown in FIG. 1) to interchange network 28 for storage within data warehouse 120.

At interchange network 28, it is determined 526 whether second transaction card 460 replaces first transaction card 458. If second transaction card 460 does not replace first transaction card 458, interchange network 28 ends 528 sub-routine 500. If second transaction card 460 replaces first transaction card 458, interchange network 28 determines 530 if first transaction card 458 was being used in a recurring transaction. In one embodiment, a table of transaction cards being used in recurring transactions is stored within data warehouse 120 and first transaction card 458 is matched to the table to determine 530 if first transaction card 458 is being used in a recurring transaction. If first transaction card 458 is not being used in a recurring transaction, interchange network 28 ends 532 sub-routine 500.

If first transaction card 458 is being used in a recurring transaction, interchange network 28 automatically pushes 534 account data relating to second transaction card 460 to merchant 24 to replace account data relating to first transaction card 458 to make the recurring transaction. More specifically, interchange network 28 automatically pushes 534 account data, for example, but not limited to, the second account number, to merchant 24 for replacing 536 the first account number being used in the recurring transaction. At merchant 24, account data relating to first transaction card 458 is replaced 536 with account data relating to second transaction card 460. The next recurring transaction authorization request from merchant 24 is processed 538 by interchange network using second transaction card 460 and, more particularly, the second account number. The table of transaction cards being used in recurring transaction is updated to replace the first account number with the second account number.

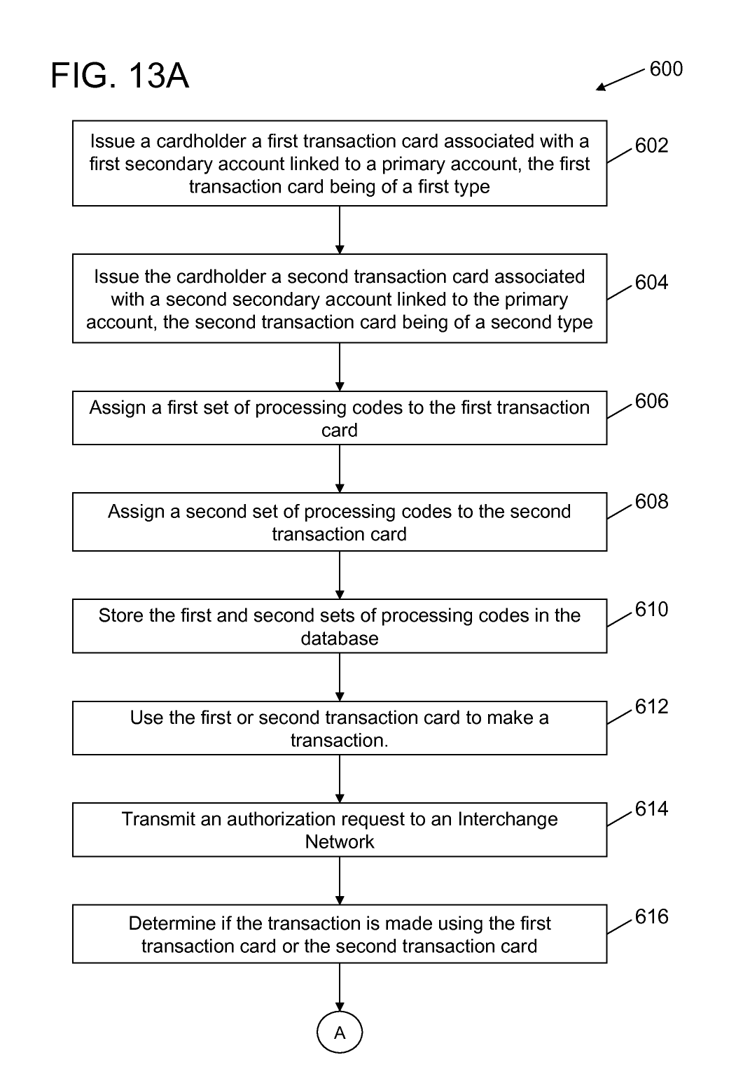

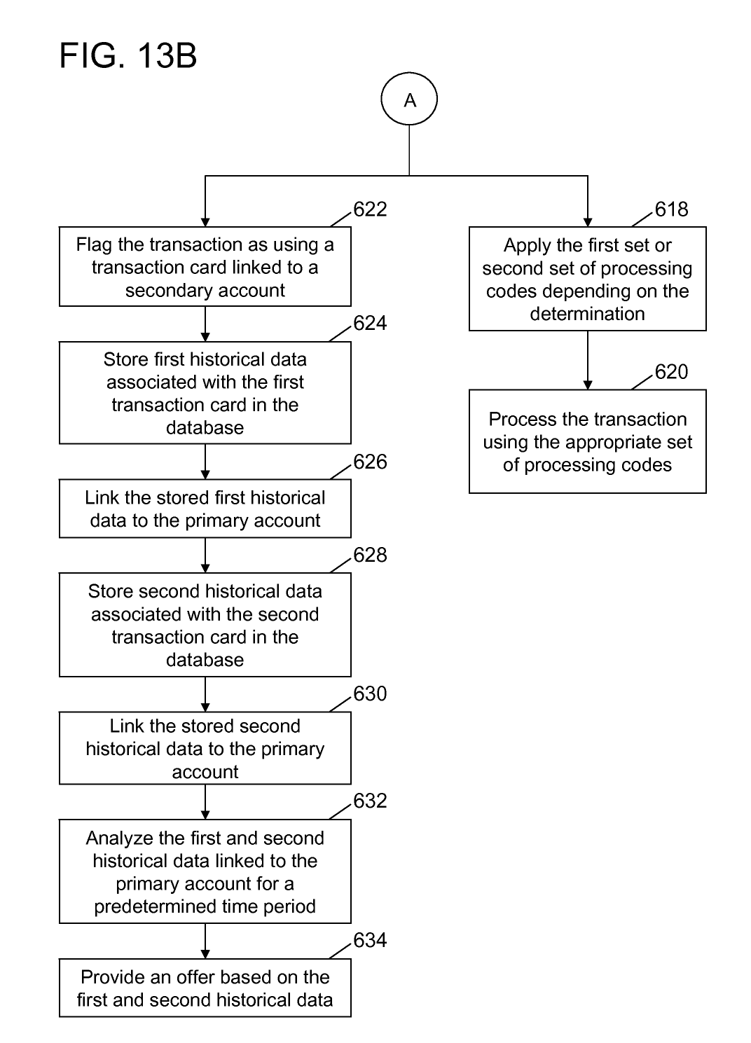

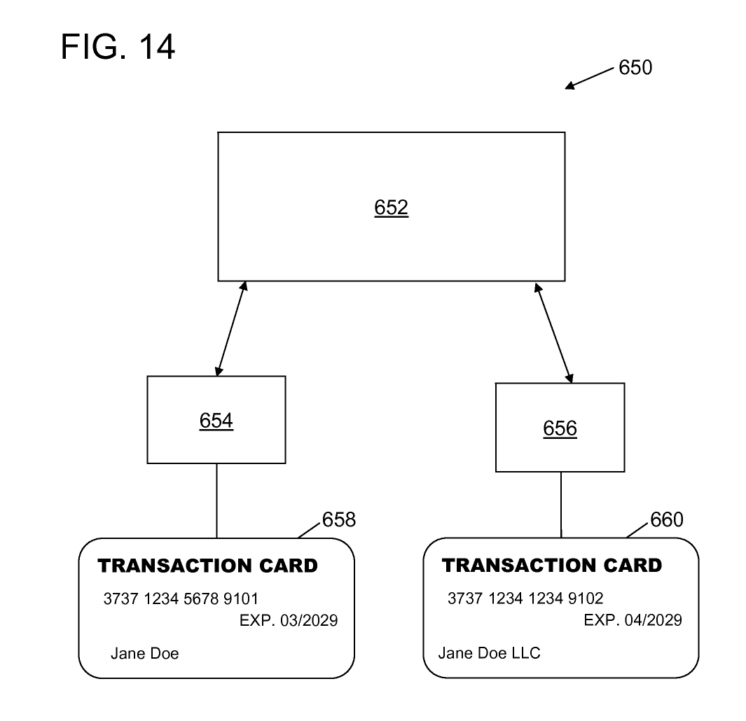

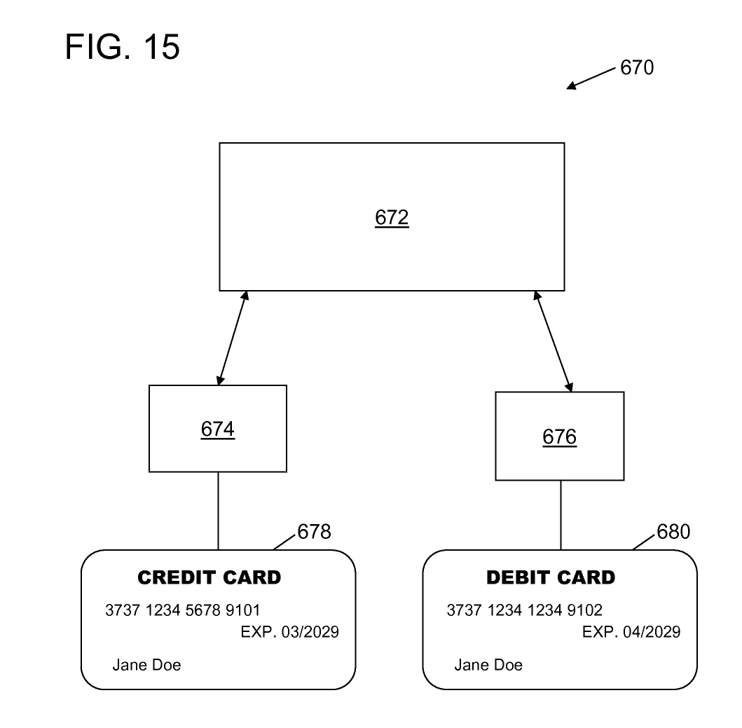

FIGS. 13A and 13B show a flow diagram of a fourth sub-routine 600 that may be used with method 200 (shown in FIG. 6). FIG. 14 is a schematic diagram illustrating an exemplary linked account 650 that may be used with sub-routine 600. FIG. 15 is a schematic diagram illustrating an alternative exemplary linked account 670 that may be used with sub-routine 600. Linked account 250 (shown in FIG. 7) and/or any other suitable linked account may also be used with sub-routine 600. In the exemplary embodiment, sub-routine 600 is a method of assigning transaction card features at the secondary account level.

Referring to FIG. 14, in the exemplary embodiment, linked account 650 includes a primary account 652 and at least two secondary accounts 654 and 656 linked to primary account 652. A transaction card 658 and 660 is associated with each secondary account 654 and 656, respectively. Transaction cards 658 and 660 are both, directly or indirectly, associated with the same cardholder at issuer 30 (shown in FIG. 1). More specifically, in the exemplary embodiment, transaction card 658 is a consumer transaction card issued to the cardholder, transaction card 660 is a business transaction card issued to the cardholder's business. As such, transaction card 658 and transaction card 660 are different types of transaction cards that may have different rates, rewards, and/or processing codes associated therewith.

Referring to FIG. 15, in the exemplary embodiment, linked account 670 includes a primary account 672 and at least two secondary accounts 674 and 676 linked to primary account 672. A transaction card 678 and 680 is associated with each secondary account 674 and 676, respectively. Transaction cards 678 and 680 are both associated with the same account at issuer 30 (shown in FIG. 1) and/or the same cardholder at issuer 30. More specifically, in the exemplary embodiment, transaction card 678 is a credit card issued to the cardholder, transaction card 680 is a debit card issued to the cardholder. As such, transaction card 678 and transaction card 680 are different types of transaction cards that may have different rates, rewards, accounts, and/or processing codes associated therewith. Linked account 650 (shown in FIG. 14) is referred to herein to describe sub-routine 600 (shown in FIGS. 13A and 13B), however it should be understood that other suitable linked accounts, including linked account 670, may be used with sub-routine 600.

Referring to FIGS. 13A, 13B, and 14, a first type of transaction card 658 (also referred to herein as “first transaction card”) is issued 602 to the cardholder. First transaction card 658 is associated with first secondary account 654, and first secondary account 654 is linked to first primary account 652 within the linked account data file. A second type of transaction card 660 (also referred to herein as “second transaction card”) is issued 604 to the cardholder. Second transaction card 660 is associated with second secondary account 656 that is linked to first primary account 652.

A first set of processing codes are assigned 606 to first secondary account 654 at interchange network 28 (shown in FIG. 1). The first set of processing codes includes an interchange rate for processing a transaction that uses first transaction card 658 over interchange network 28. A second set of processing codes are assigned 608 to second secondary account 656 at interchange network 28. The second set of processing codes includes an interchange rate for processing a transaction that uses second transaction card 660 over interchange network 28. The interchange rate for first secondary account 654 is different from the interchange rate for second secondary account 656. The first and second sets of processing codes are stored 610 in data warehouse 120.

The cardholder uses 612 either first transaction card 658 or second transaction card 660 to make a purchase at POS device 115 (shown in FIG. 2) associated with merchant 24 (shown in FIG. 1). Alternatively, the cardholder uses 612 either first transaction card 658 or second transaction card 660 to make any suitable transaction. In the exemplary embodiment, merchant 24 transmits 614 a transaction authorization request from POS device 115 to server system 112, which is associated with interchange network 28. Interchange network 28 determines 616 whether the purchase is made using first transaction card 658 or second transaction card 660, and then applies 618 the corresponding set of processing codes to the transaction. Interchange network 28 processes 620 the transaction as described with respect to FIG. 1 to complete the transaction using the appropriate processing codes.

Interchange network 28 also flags 622 the transaction as being one using transaction card 658 or 660 that is associated with secondary account 654 or 656, respectively. When first transaction card 658 is used to make a transaction, first historical transaction data associated with first transaction card 658 is stored 624 in data warehouse 120 and is linked 626 to first primary account 652. When second transaction card 660 is used to make a transaction, second historical transaction data associated with second transaction card 660 is stored 628 in data warehouse 120 and is linked 630 to first primary account 652. The first and second historical data are analyzed 632 for a predetermined period of time, such as three months or twelve months. An offer, such as reward points and/or other programs, is provided 634 to the cardholder based on the first and/or second historical transaction data linked to first primary account 652.

The above-described systems and methods enable a plurality of transaction cards issued to members of a group and/or to the same cardholder to be linked together for analytic and/or other purposes. The embodiments described herein also provide data continuity when a transaction card is replaced and/or provide combined data when transaction cards are related. More specifically, the embodiments described herein include a linked account group having a primary account and a plurality of secondary accounts linked to the primary account to facilitate assigning processing codes to transaction cards within the linked account. Assigning the processing codes can include assigning a credit limit at a primary account level and assigning portions of the credit limit at a secondary account level to each transaction card in the linked account. For example, a company has an overall credit limit associated with the primary account, and the company can apportion the credit limit among each employee having a transaction card associated with a secondary account.

Moreover, the above-described embodiments can be combining to facilitate providing combined and continuous data. For example, if a family member loses a transaction card, the lost transaction card can be replaced, and the replacement card can be linked to the lost transaction card and to transaction cards issued to other family members. As such, the systems and method described herein can be applied selectively depending on the characteristics of the transaction cards issued to a group of cardholders and/or to the same cardholder.

A technical effect of the systems and methods described herein includes at least one of: (a) uploading a linked account data file from an issuer, wherein the linked account data file includes linked account information including a plurality of linked accounts, each linked account includes a primary account assigned to a cardholder and a plurality of secondary accounts linked to the primary account, each primary account has a unique primary account number, and each of the plurality of secondary accounts linked to the primary accounts having a unique secondary account number; (b) flagging each secondary account number as being part of a linked account; (c) when a cardholder uses a transaction card having an account number assigned thereto to make a purchase at a merchant, receiving a transaction authorization request from the merchant, wherein the transaction card is associated with a secondary account within a linked account; and (d) processing a transaction authorization request to determine that the transaction card is associated with a flagged secondary accounts.

Exemplary embodiments of methods and systems for linking transaction cards are described above in detail. The methods and systems are not limited to the specific embodiments described herein, but rather, components of systems and/or steps of the methods may be utilized independently and separately from other components and/or steps described herein. For example, the methods may also be used in combination with other account systems and methods, and are not limited to practice with only the transaction card account systems and methods as described herein. Rather, the exemplary embodiment can be implemented and utilized in connection with many other data storage and analysis applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for processing a financial transaction using an interchange network computer coupled to a database, the financial transaction initiated with a transaction card associated with a linked account, said method comprising:
receiving, at the interchange network computer, a linked account data file for the first transaction card, the linked account data file including data associating the first transaction card with a first secondary account, and data linking the first secondary account to a first primary account;
storing the linked account data file within the database;
receiving a first authorization request message for the first financial transaction;
determining, based on data included within the first authorization request message, that the first transaction card is associated with the first secondary account; and
processing the first authorization request message by applying at least one processing code associated with the first primary account to the first financial transaction.

2. A method in accordance with claim 1 wherein storing the linked account data file comprises storing at least one processing code associated with the first primary account within the database, the processing codes including an interchange rate.

3. A method in accordance with claim 2 wherein determining that the first transaction card is associated with the first secondary account further comprises:
detecting, within the first authorization request message, an account identifier corresponding to the first secondary account;
identifying the first secondary account as being linked to the first primary account; and
applying an interchange rate associated with the first primary account to the first financial transaction.

4. A method in accordance with claim 2 further comprising:
receiving, at the interchange network computer, an updated linked account data file, the updated linked account data file including data associating a second transaction card with a second secondary account, and data linking the second secondary account to the first primary account;
storing the updated linked account data file within the database;
receiving, at the interchange network computer, a second authorization request message for a second financial transaction initiated with the second transaction card; and
processing the second authorization request message by applying the at least one processing code associated with the first primary account to the second financial transaction.

5. A method in accordance with claim 1 wherein storing the linked account data file within the database further comprises:
storing first historical transaction data within the database including data representing goods or services previously purchased using the first financial transaction card including at least purchase amounts and purchase dates; and
linking the first historical transaction data within the database to the first primary account.

6. A method in accordance with claim 5 further comprising:
receiving, at the interchange network computer, an updated linked account data file, the updated linked account data file including data associating a second transaction card with a second secondary account, and data linking the second secondary account to the first primary account;
storing the updated linked account data file within the database;
receiving, at the interchange network computer, a second authorization request message for a second financial transaction initiated with the second transaction card;
processing the second authorization request message by applying at least one processing code associated with the first primary account to the second financial transaction;
storing transaction data associated with the second authorization request message within the database as second historical transaction data; and
linking the second historical transaction data to the first primary account.

7. A method in accordance with claim 5 further comprising:
analyzing historical transaction data stored within the database that is linked to the first primary account; and
providing a rewards program offer to the cardholder based the historical transaction data.

8. A method in accordance with claim 1 wherein receiving a first authorization request message for the first financial transaction further comprises:
determining that the first transaction card has been replaced with a second transaction card, the second transaction card associated with a second secondary account, the second secondary account linked to the first primary account;
determining, at the interchange network computer, that the first transaction card is being used in a recurring transaction; and
automatically transmitting account data associated with the second transaction card to the merchant for updating records.

9. A method in accordance with claim 8 wherein determining that the first transaction card is being used in a recurring transaction includes identifying recurring payment data associated with the first secondary account in said database.

10. A network-based system for processing a financial transaction initiated by application of a transaction card that is associated with a linked account, said system comprising:
a client device associated with a merchant;
a database associated with an interchange network for storing a linked account data file; and
a server system coupled to said client device and said database, said server system associated with the interchange network, said server system configured to:
receive the linked account data file from an issuer of the transaction card, the linked account data file including data associating the transaction card with a first secondary account, and data linking the first secondary account to a first primary account;
store the linked account data file within said database;
receive, from said client device, an authorization request for the financial transaction;
determine, based at least partially on the authorization request, that the transaction card is associated with the first secondary account; and
process the authorization request by applying at least one processing code associated with the first primary account to the financial transaction.

11. A network-based system in accordance with claim 10 wherein the authorization request includes an account identifier that identifies the transaction card as being associated with a linked account, said server system configured to:
detect the account identifier after receiving the authorization request;
determine, based on the account identifier, that the transaction card is associated with the first secondary account; and
apply an interchange rate processing code associated with the first primary account when processing the authorization request.

12. A network-based system in accordance with claim 10, said server system further configured to:
receive an updated linked account data file upon generation of a second secondary account linked to the first primary account, the updated linked account data file including data associating a second transaction card with the second secondary account, and data linking the second secondary account to the first primary account;
storing the updated linked account data file within said database;
receiving a second authorization request for a second financial transaction initiated with the second transaction card; and
processing the second authorization request by applying at least one processing code associated with the first primary account to the second financial transaction.

13. A network-based system in accordance with claim 10 wherein storing the linked account data file within said database further comprises:
storing first historical transaction data within said database including data representing goods or services previously purchased using the first financial transaction card including at least purchase amounts and purchase dates; and
linking the first historical transaction data within said database to the first primary account.

14. A network-based system in accordance with claim 13 wherein said server system is further configured to:
receive an updated linked account data file, the updated linked account data file including data associating a second transaction card with a second secondary account, and data linking the second secondary account to the first primary account;
store the updated linked account data file within the database;
receive a second authorization request for a second financial transaction initiated with the second transaction card;
process the second authorization request by applying at least one processing code associated with the first primary account to the second financial transaction;
store transaction data associated with the second authorization request message within said database as second historical transaction data; and
link the second historical transaction data to the first primary account.

15. A network-based system in accordance with claim 13 wherein said server system is further configured to:
analyze historical transaction data stored within said database that is linked to the first primary account; and
provide a rewards program offer to the cardholder based on the historical transaction data.

16. A network-based system in accordance with claim 10 wherein said server system is further configured to:
receive an updated linked account data file, the updated linked account data file including data associating a second transaction card with a second secondary account, and data linking the second secondary account to the first primary account;
store the updated linked account data file within the database;
determine that the first financial transaction is used in a card-not-present recurring payment (CNP/RP) transaction between the cardholder and a merchant;
determine that the first transaction card has been replaced with the second transaction card; and
automatically transmit account data associated with the second transaction card to the merchant for updating records.

17. A network-based system in accordance with claim 10 wherein said server system is further configured to:
determine that the first transaction card has been replaced with a second transaction card associated with the second secondary account;
determine that the first transaction card is being used in a recurring transaction by identifying recurring purchase data associated with the first secondary account in said database; and
automatically transmit account data associated with the second transaction card to the merchant for updating records.

18. A computer for processing a financial transaction using a transaction card account, the computer coupled to a database and configured to upload a linked account data file from an issuer, the linked account data file includes data linking at least one secondary account to a primary account, said computer configured to:
receive a linked account data file for a first transaction card, the linked account data file including data associating the first transaction card with a first secondary account, and data linking the first secondary account to a first primary account;
store the linked account data file within the database;
receive a first authorization request message for the first financial transaction;
determine, based on data included within the first authorization request message, that the first transaction card is associated with the first secondary account; and
process the first authorization request message by applying at least one processing code associated with the first primary account to the first financial transaction.

19. A computer in accordance with claim 18 further configured to store processing codes associated with the first primary account within the database.

20. A computer in accordance with claim 18 further configured to:
detect, within the first authorization request message, an account identifier corresponding to the first secondary account;
identify the first secondary account as being linked to the first primary account; and
apply an interchange rate associated with the first primary account to the first financial transaction.

21. A computer in accordance with claim 18 further configured to:
receive an updated linked account data file, the updated linked account data file including data associating a second transaction card with a second secondary account, and data linking the second secondary account to the first primary account;
store the updated linked account data file within the database;
receive a second authorization request message for a second financial transaction initiated with the second transaction card; and
process the second authorization request message by applying at least one processing code associated with the first primary account to the second financial transaction.

22. A computer in accordance with claim 18 further configured to:
store first historical transaction data within the database including data representing goods or services previously purchased using the first financial transaction card including at least purchase amounts and purchase dates; and
link the first historical transaction data within the database to the first primary account.

23. A computer in accordance with claim 22 further configured to:
receive a second authorization request message for a second financial transaction initiated with the second transaction card;
process the second authorization request message by applying at least one processing code associated with the first primary account to the second financial transaction;
store transaction data associated with the second authorization request message within the database as second historical transaction data; and
link the second historical transaction data to the first primary account.

24. A computer in accordance with claim 22 further configured to:
analyze historical transaction data stored within the database that is linked to the first primary account; and
provide a rewards program offer to the cardholder based on the historical transaction data.

25. A computer in accordance with claim 18 further configured to:
determine that the first transaction card has been replaced with a second transaction card associated with the second secondary account;
determine that the first transaction card is being used in a recurring transaction by identifying recurring purchase data associated with the first secondary account in said database; and
automatically transmit account data associated with the second transaction card to the merchant for updating records.

26. A computer program embodied on a non-transitory computer readable medium for processing a financial transaction using an interchange network computer coupled to a database, the financial transaction initiated with a transaction card associated with a linked account, said program comprising at least one code segment for instructing the computer to:
receive a linked account data file for a first transaction card, the linked account data file including data associating the first transaction card with a first secondary account, and data linking the first secondary account to a first primary account;
store the linked account data file within the database;
receive a first authorization request message for the first financial transaction;
determine, based on data included within the first authorization request message, that the first transaction card is associated with the first secondary account; and
process the first authorization request message by applying at least one processing code associated with the first primary account to the first financial transaction.

27. A computer program in accordance with claim 26 further comprising at least one code segment for instructing the computer to:
receive an updated linked account data file, the updated linked account data file including data associating a second transaction card with a second secondary account, and data linking the second secondary account to the first primary account;
store the updated linked account data file within the database;
receive a second authorization request message for a second financial transaction initiated with the second transaction card; and
process the second authorization request message by applying the at least one processing code associated with the first primary account to the second financial transaction.

28. A computer program in accordance with claim 27 further comprising at least one code segment for instructing the computer to:
determine that the first transaction card has been replaced with the second transaction card;
determine that the first transaction card is being used in a recurring transaction with a merchant; and
automatically transmit account data associated with the second transaction card to the merchant for updating records.

29. A computer program in accordance with claim 27 further comprising at least one code segment for instructing the computer to:
store first historical transaction data within the database including data representing goods or services purchased using the first transaction card;
store second historical transaction data within the database including data representing goods or services purchased using the second transaction card, wherein the second financial transaction card is associated with a second secondary account; and
linking the first historical transaction data and the second historical transaction data to the first primary account.

30. A computer program in accordance with claim 29 further comprising at least one code segment for instructing the computer to:
analyze historical transaction data stored within the database that is linked to the first primary account; and
provide a rewards program offer to the cardholder based the historical transaction data.
